(19) United States
(12) Patent Application Publication
(10) Pub. No.: US 2019/0216239 A1
(43) Pub. Date: Jul. 18, 2019

(54) APPARATUS FOR CATCHING IMPROPERLY ATTACHED GARMENT MANIKIN LIMBS

(71) Applicant: Hangerlogic Inc., LaSalle (CA)

(72) Inventor: Kevin Atkinson, Woodbridge (CA)

(73) Assignee: Hangerlogic Inc., LaSalle (CA)

(21) Appl. No.: 16/249,051

(22) Filed: Jan. 16, 2019

Related U.S. Application Data
(60) Provisional application No. 62/617,822, filed on Jan. 16, 2018.

(51) Int. Cl. A47F 8/02; F16B 1/00; F16B 45/00

(52) U.S. Cl. CPC A47F 8/02; F16B 2001/0035; F16B 45/00; F16B 1/00

(57) ABSTRACT

A garment manikin (mannequin) limb catcher to prevent damage to manikin limbs caused by accidental bumps once the limb is attached to a manikin torso. In situations where a manikin limb is attached to a torso by magnets, a bump to the limb can break the magnetic holding force, thus causing the limb to fall. This invention describes a limb with lead-in pin that has a bent tip, the pin being inserted into a hole on the torso. If bumped, the bent tip will catch on the hole's rim and prevent the limb from falling. In another variant, the torso can have the lead-in pin with a bend, and the limb has a hole. The pin with a bent tip acts as a catching element, and the hole acts as a stopping element.

This application claims the priority of U.S. Provisional Patent application No. 62/617,822, filed on Jan. 16, 2018.

The present invention relates to an apparatus for catching improperly-attached garment display manikin limbs during the dressing process. The present apparatus prevents limbs from falling onto the floor if accidentally released by the manikin's dresser before secure attachment, or in cases where the dresser erroneously believes the limb is properly attached, but it is not. The apparatus is useful for manikins with a pin- or dowel-to-hole arrangement for attaching limbs into the torso. The pin or dowel can be either on the limb or on the torso. This invention increases the efficiency and cost-effectiveness of a garment retail store.

### BACKGROUND

In the retail garment store industry, manikins are often used as displays for clothes. The store's employees have to change the manikin displays at regular intervals as new arrivals are showcased. Dressing a manikin in clothes with sleeves involves first putting a garment on the manikin's torso, then threading the limbs through the sleeves.

Threading the limbs through the sleeves is not an easy process, and needs close attention by the dresser. One of the most challenging steps is making sure the limb is securely attached to the torso after the garment has been dressed on the manikin. If the limb-to-torso connection involves a pin or a dowel that goes into a corresponding hole, the dresser has to make sure that this connection is secure: the pin has to be fully inserted into its hole, and a positive connection must be made between the limb and torso. Otherwise, when the dresser releases the limb, it risks falling out of the sleeve and potentially breaking on the floor.

In a hypothetical situation, through the garment, the dresser can ascertain by feel that the pin has gone inside the hole, and trusts that the limb is secure. In reality, only half of the pin has actually gone into the hole. Gravity will pull the limb down, the pin slides out of the hole, and the limb falls. The present invention eliminates this unintended result.

There is known U.S. Pat. No. 9,538,866 for “MAGNETICALLY COUPLING MANIKIN JOINTS” for a manikin with such a pin-to-hole arrangement. However, this pin has no means to prevent it from slipping out of its hole and letting the limb fall to the floor.

There is also known CN104273988 for “AVOIDING FALL-OFF STRUCTURE FOR LIMBS OF EXHIBITED MANIKIN”, for a dowel pin and hole. However, this invention is not as effective as the present apparatus because the tip of the pin that functions as a limb catcher is ball-shaped, and therefore can slip out of the hole far easier than the present invention if bumped. The present invention also has two catching holes as a redundancy system, in case the limb is bumped out of the first catching hole, while CN104273988 does not.

### OBJECT OF THE INVENTION

The present invention saves time and money for garment retail stores. During dressing of display manikins, if the dresser makes an error, this can be costly if the manikin's limb falls to the floor and breaks. Some limbs are very aesthetically intricate, with fingers that can break off. If this happens, the limb will have to be thrown out.

This invention catches the limb before it falls to the floor, and lets the dresser quickly correct a mistake without having to re-thread the limb through the sleeve or buy a new limb. The preferred embodiment has a built-in redundancy to assure the limb from falling.

### BRIEF DESCRIPTION OF THE DRAWINGS

FIG. 1 shows a perspective view of the limb portion's limb catcher of the present invention.

FIG. 2 shows a perspective view of FIG. 1, with the torso's portion of the present invention.

FIG. 3 shows a perspective view of the present invention when a limb is properly attached to the torso.

FIG. 4 shows a reverse perspective view of FIG. 2

FIG. 5 shows a side cross-sectional view of the present invention's operation should a limb not be properly attached to the torso.

FIG. 6 shows a side cross-sectional view of the redundant feature of the present invention's operation.

### DETAILED DESCRIPTION OF THE PREFERRED EMBODIMENT

The preferred embodiment of the present invention comprises, on the limb attachment means portion, a bend or hook at the tip of the lead-in pin, and two holes on the torso's attachment means portion. The holes, in the torso's lead-in base and magnet room, are oriented in such a way that if the lead-in pin's hook is bumped out of the first hole (in the magnet room), the sway of the limb will orient the hook to catch onto the second hole (in the lead-in base). Thus, the present invention will catch a limb before it falls to the floor.

In the preferred embodiment, the pin should be between 2″ and 3″, with a diameter of around ½″. The pin should be made of plastic, more specifically polycarbonate or ABS, but can be made of any material.

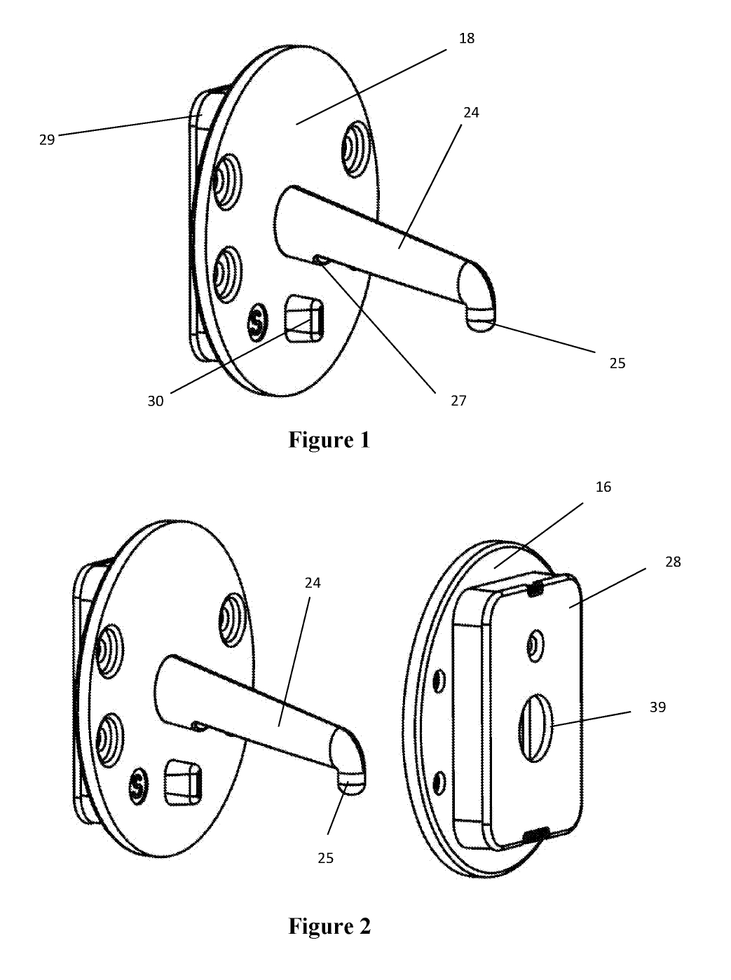

Referring now to the drawings, FIG. 1 shows the lead-in base 18, which would typically be on the limb portion of a manikin, but not necessarily. Lead-in base 18 is of a round disk-shaped configuration, and comprises lead-in pin 24 substantially in its center. A location block 30, comprising a rectangular protrusion, is substantially between lead-in pin 24 and the rim of base 18. Magnet room 29 is located on base 18 on the opposite face to lead-in pin 24. Lead-in pin 24 comprises a catcher 25 on its distal end, comprising a bend in said pin 24. Said bend is substantially parallel to base 18's plane.

FIG. 2 shows the relationship of lead-in base 18 and attach base 16. Attach base 16 is of a round disk-shaped configuration similar to lead-in base 18. A magnet room 28 is attached to one face of attach base 16, opposite to attach base 16's face that connects to lead-in base 18. Magnet room 28 accommodates hole 39 substantially in its middle, through which lead-in pin 24 is inserted.

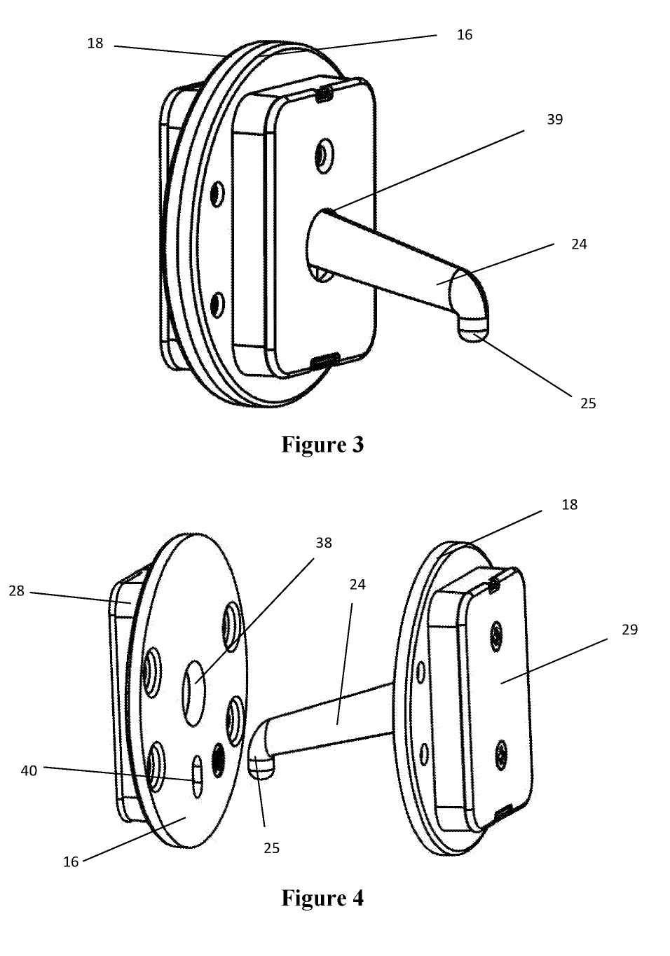

FIG. 3 shows the configuration of attach base 16 and lead-in base 18 when a manikin limb is properly attached to the manikin torso. Lead-in pin 24 protrudes through hole 39, and bases 16 and 18 are in contact so that magnets (not shown) of magnet rooms 28 and 29 exert enough attraction force to securely hold the manikin's limb on torso.

FIG. 4 shows a reverse view of FIG. 2, with lead-in hole 38 being substantially in the base 16's center. Attach base 16's location block guide hole 40 is substantially the mid-point between lead-in hole 38 and attach base 16's rim. When a limb and torso are properly connected, lead in base 18's location block 30 (seen on FIG. 1) is fully inserted into location block guide hole 40.

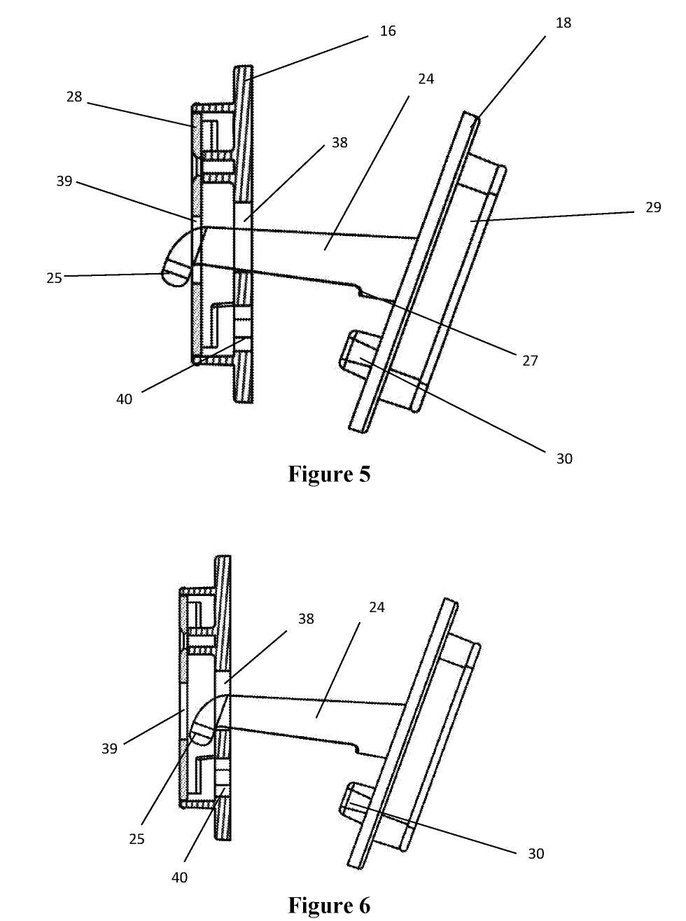

FIG. 5 shows the orientation of the apparatus if a manikin's limb is not properly secured to the manikin's torso. Gravity pulls the limb, depending from lead-in base 18, downwardly towards the ground. Lead-in pin 24 slides out of holes 38 and 39 until catcher 25 abuts lead-in hole 39 in magnet room 28 of attach base 16. Catcher 25's configuration does not permit lead-in pin 24 from sliding out of hole 39 any further, and the limb assembly hangs on the manikin's torso, ready for another attempt to properly connect it to the torso.

FIG. 6 shows an eventuality where a limb is already dangling as shown in FIG. 5, and the dresser accidentally bumps the limb with enough force to knock out catcher 25 from its resting position on hole 39. Due to the orientation of holes 38 and 39, catcher 25 will fall into the space created between magnet room 28's hole 39 and attach base's hole 38. Catcher 25 will subsequently be retained by hole 38, preventing the limb from falling.

Catcher 25 comprises a catching element, and holes 38 and 39 comprise a stopping element.

In operation, a dresser threads a garment onto a limb, and through the garment will locate lead-in pin 24 by feel. Dresser will then orient lead-in pin 24 so that catcher 25 goes through holes 38 and 39. Dresser then pushes the limb against the torso so that the attraction force of magnets (not shown) in magnet rooms 28 and 29 engage their attraction force, and securely connect the limb to the torso.

Once lead-in pin 24 is inserted through holes 38 and 39, if the dresser makes an error in judgment and assumes that the limb is securely connected to the torso, gravity will pull the limb to the floor, and lead-in pin 24 will slide out of holes 38 and 39. At the end of pin 24's slide, catcher 25 will engage hole 39 and prevent limb from falling to the floor. If, once the dresser sees the mistake, the dresser accidentally bumps the limb with enough force to dislodge the contact between catcher 25 and hole 39, catcher 25 will catch onto hole 38 in attach base 16, thus giving the dresser a second chance to correct the initial error.

Catcher 25 can be longer than the preferred embodiment, but it cannot be larger in diameter than holes 38 and 39. Another variation is possible for holes 38 and 39: an oval rather than a circular hole. This will make inserting catcher 25 easier, as there will only be one way to insert it into holes 38 and 39.

1. An apparatus for catching improperly-attached garment manikin limbs comprising:
a lead-in pin attached substantially to a center of
a lead-in base,
said lead-in base is attached to a face of one portion of said manikin,
a magnet room is located of an opposite face of said lead-in base;
an attach-base attached to another portion of said manikin,
said attach-base comprising
a magnet room attached to an opposite side of an attach-base face,
said attach-base is provided with
a front attach-base hole located substantially in the middle of said attach-base face,
a back attach-base hole located substantially in the middle of said magnet room of said attach-base;
said lead-in pin is provided with
a bend or hook formed on a tip of said lead-in pin,
said lead-in pin is adapted to be fully inserted into said front attach-base hole and said back attach-base hole to keep said lead-in base to be magnetically attached to said attach-base when in use;
wherein said bend of said lead-in pin is adapted to be caught in said back attach-base hole and said front attach-base in hole if said one portion of said manikin is bumped from said another portion of said manikin.

2. An apparatus for catching improperly-attached garment manikin limbs according to claim 1, wherein the length of said lead-in pin is between 2″ and 3″ and diameter is substantially ½″.

3. An apparatus for catching improperly-attached garment manikin limbs according to claim 1, wherein said bend of said lead-in pin is formed substantially parallel to said attach-base face's plane.

4. An apparatus for catching improperly-attached garment manikin limbs according to claim 1, wherein said one portion of said manikin is a limb and another portion of said manikin is a torso.

5. An apparatus for catching improperly-attached garment manikin limbs according to claim 1, wherein said one portion of said manikin is a torso and another portion of said manikin is a limb.

6. An apparatus for catching improperly-attached garment manikin limbs according to claim 1, wherein said lead-pin is capable of sliding out of said back attach-base hole, but will be not able to slide out of said front attach-base hole, keeping said apparatus suspended on said manikin's torso, ready for another attempt to properly connect it to said torso.

7. An apparatus for catching improperly-attached garment manikin limbs according to claim 1, wherein said front attach-base hole and said back attach-base hole have a substantially circular configuration.

8. An apparatus for catching improperly-attached garment manikin limbs according to claim 1, wherein said front attach-base hole and said back attach-base hole have a substantially oval configuration.

9. An apparatus for catching improperly-attached garment manikin limbs comprising:
a lead-in pin attached substantially to a center of
a lead-in base,
said lead-in base is attached to a face of one portion of said manikin,
a magnet room is located of an opposite face of said lead-in base;
an attach-base attached to another portion of said manikin,
said attach-base comprising
a magnet room attached to an opposite side of an attach-base face,
said attach-base is provided with
a front attach-base hole located substantially in the middle of said attach-base face,
a back attach base hole located substantially in the middle of said magnet room of said attach-base;
said lead-in pin is provided with
a catching element formed on a tip of said lead-in pin,
said lead-in pin is adapted to be fully inserted into said front attach-base hole and said back attach-base hole to keep said lead-in base to be magnetically attached to said attach-base when in use,
wherein said catching element of said lead-in pin is adapted to be caught in said back attach-base hole and said front attach-base hole if said one portion of said manikin is bumped from said another portion of said manikin.

10. An apparatus for catching improperly-attached garment manikin limbs according to claim 9, wherein said catching element is bend or hook formed on the end of said lead-in pin.

11. An apparatus for catching improperly-attached garment manikin limbs according to claim 10, wherein the length of said lead-in pin is between 2″ and 3″ and diameter substantially ½″.

12. An apparatus for catching improperly-attached garment manikin limbs according to claim 10, wherein said bend of said lead-in pin is formed substantially parallel to said attach base face's plane.

13. An apparatus for catching improperly-attached garment manikin limbs according to claim 10, wherein said one portion of said manikin is a limb and another portion of said manikin is a torso.

14. An apparatus for catching improperly-attached garment manikin limbs according to claim 10, wherein said one portion of said manikin is a torso and another portion of said manikin is a limb.

15. An apparatus for catching improperly-attached garment manikin limbs according to claim 10, wherein said lead-pin is capable to slide out from said back attach-base hole, but will be not able to slide out from said front attach-base hole, keeping said apparatus hanging on said manikin's torso ready for another attempt to properly connect it to said torso.

16. An apparatus for catching improperly-attached garment manikin limbs according to claim 10, wherein said front attach-base hole and said back attach-base hole have a substantially circular configuration.

17. An apparatus for catching improperly-attached garment manikin limbs according to claim 10, wherein said front attach-base hole and said back attach-base hole have a substantially oval configuration.

18. An apparatus for catching improperly-attached garment manikin limbs comprising:
a lead-in pin attached substantially to a center of
a lead-in base,
said lead-in pin is provided with
a catching element formed on a tip of said lead-in pin,
said lead-in base is attached to a face of one portion of said manikin,
a magnet room is located of an opposite face of said lead-in base,
and
an attach-base attached to another portion of said manikin,
said attach-base comprising
a magnet room attached to an opposite side of an attach-base face;
said attach-base is provided with a stopping element adapted to catch said stopping element of said lead-in pin.

19. An apparatus for catching improperly-attached garment manikin limbs according to claim 18, wherein said catching element comprises a downwardly bend at the distal end of said lead-in pin.

20. An apparatus for catching improperly-attached garment manikin limbs according to claim 18, wherein said stopping element comprises two holes in said attach-base, being a front hole formed on the face of said attach-base and a rear hole formed in said magnet room of said attach-base.
